(19) United States
(12) Patent Application Publication
(10) Pub. No.: US 2026/0251485 A1
(43) Pub. Date: Aug. 27, 2026

(54) SENSOR ARRANGEMENT WITH A MODULAR SCREW HEAD

(71) Applicant: TDK Electronics AG, München (DE)

(72) Inventors: Jordi BASIANA MARTÍ, Berlin (DE); Christoph Johannes DREES, Berlin (DE); Stefan KUSCHEL, Stahnsdorf (DE); Iurii NIKOLCHENKO, Berlin (DE); Patrick VAN DOOREN, Berlin (DE)

(21) Appl. No.: 19/463,467

(22) Filed: Jan. 29, 2026

(30) Foreign Application Priority Data
Feb. 24, 2025 (DE) 102025106857.7

(51) Int. Cl. G01D 11/24; G01D 11/30; G01D 21/02; G01K 1/12; G01K 1/14; G01K 1/26; G01L 19/06; G01L 19/14

(52) U.S. Cl. CPC G01D 11/245; G01D 11/305; G01D 21/02; G01K 1/12; G01K 1/146; G01K 1/26; G01L 19/0618; G01L 19/0681; G01L 19/147

(57) ABSTRACT

A sensor arrangement is described which comprises a sensor element, a sensor port, a screw head and a sensor control unit. The sensor element transforms a physical quantity into a measurable electrical quantity. The sensor port comprises a carrier plate and a threaded connector that is connected to the carrier plate. The threaded connector is configured to enable a simple mounting and demounting of the sensor arrangement to a component containing a fluid to be measured by the sensor. Mounting of the sensor arrangement can be achieved by screwing the sensor arrangement onto the component. The screw head is configured to be driven by a mating tool to perform a rotational movement around an axis parallel to the mounting direction. The sensor control unit electrically controls the operation of the sensor element. The sensor element is arranged directly on the sensor port. The screw head is configured to engage with the carrier plate in a way as to allow the transfer of the rotational movement of the screw head to the sensor port. The sensor control unit is arranged in a way that the sensor control unit is thermally decoupled from the sensor port.

### CROSS-REFERENCE TO RELATED APPLICATIONS

This application claims the benefit of and priority to Germany Patent Application No. 102025106857.7, filed Feb. 24, 2025, which is incorporated herein by reference in its entirety.

### FIELD

The present invention relates to a sensor arrangement with a modular screw head.

### BACKGROUND

Sensor arrangements for high pressure and high temperature operation are used in almost every industrial field. One such field may be the temperature measurement or pressure measurement of fluids such as in a vehicle heat exchanger, for example.

Another operating field may be the hydrogen systems of automotive or industrial applications. However, the application of the present invention is not limited to these.

U.S. Ser. No. 11/486,436 B2 describes a wrench width adapter.

It is the task of the present invention to provide a sensor arrangement for high pressure and high temperature operation with improved heat resistance.

This task can at least partly be achieved by a sensor arrangement according to claim 1. In the dependent claims, embodiments of features are provided which may provide additional advantages.

### SUMMARY

A sensor arrangement is described which comprises a sensor element, a sensor port, a screw head and a sensor control unit. The sensor element transforms a physical quantity into a measurable electrical quantity. The sensor port comprises a carrier plate and a threaded connector that is connected to the carrier plate. The threaded connector is configured to enable a simple mounting and demounting of the sensor arrangement to a component containing a fluid to be measured by the sensor. Mounting of the sensor arrangement can be achieved by screwing the sensor arrangement onto the component. The screw head is configured to be driven by a mating tool to perform a rotational movement around an axis parallel to the mounting direction. The sensor control unit electrically controls the operation of the sensor element. The sensor element is arranged directly on the sensor port. The screw head is configured to engage with the carrier plate in a way as to allow the transfer of the rotational movement of the screw head to the sensor port. This enables the utilization of the mating tool of the screw head to mount the sensor arrangement onto the component containing the fluid to be measured by screwing the threaded connector into the component. The sensor control unit is arranged in a way that the sensor control unit is thermally decoupled from the sensor port.

The sensor port comprises a carrier plate and a threaded connector with the threaded connector enabling the connection of the sensor arrangement to a component containing a fluid to be measured, for example a pipe.

According to an embodiment, the threaded connector extends in the mounting direction.

According to an embodiment, the threaded connector is arranged on a side of the carrier plate different from the side of the carrier plate the sensor element is arranged on. The threaded connector may be arranged on the carrier plate on a side of the carrier plate facing in the mounting direction and the sensor element may be arranged on the carrier plate on a side of the carrier plate facing away from the mounting direction. Arranging the sensor element on a side of the carrier plate facing away from a mounting direction allows the sensor element to only be in direct contact with the fluid to be measured with its sensitive surface. The remaining surfaces of the sensor are not exposed to the high pressures occurring in the fluid. This improves the longevity of the sensor element, as it is exposed less to potential high pressures of the fluid.

According to an embodiment, the threaded connector is arranged on a side of the carrier plate different from the side of the carrier plate a connection of the sensor element to the carrier plate is arranged on. The threaded connector may be arranged on the carrier plate on a side of the carrier plate facing in the mounting direction and the connection of the sensor element to the carrier plate may be arranged on a side of the carrier plate facing away from the mounting direction. The sensor element itself can be placed on either side of the carrier plate, allowing for the placement of the sensor element, for example a temperature sensor, inside the fluid to improve the sensor element's measurement's results.

The threaded connector and the side of the carrier plate facing in mounting direction may be in direct contact with the fluid to be measured. In order to reduce the corrosion of the threaded connector, its material may be the same material as the material of the component containing the fluid. A material commonly used for components containing a fluid is aluminum. In order to reduce the corrosion of the side of the carrier plate facing in mounting direction, its material may be the same material as the material of the threaded connector.

The threaded connector may comprise or consist of a metal material. Preferably, aluminum or stainless steel can be used, for example. As mentioned above, aluminum provides advantageous characteristics concerning corrosion resistance.

The carrier plate preferably comprises or consists of a metal material as well, as for example aluminum or stainless steel.

According to an embodiment, the overall thickness of the carrier plate is between 2.5 mm and 3 mm, for example 2.75 mm, allowing the carrier plate to withstand the forces acting on the carrier plate, applied by the pressure of the fluid to be measured.

According to an embodiment, the carrier plate and the threaded connector may be formed as one single element, enabling a reduction of the number of individual components that are required for the assembly of the sensor arrangement. Furthermore, a manufacturing step of connecting the threaded connector to the carrier plate, for example by welding, can be omitted, resulting in a simpler manufacturing process. If the threaded connector and the carrier plate are formed as one single element, they comprise the same material. Preferably, a metal material may be used, as for example aluminum or stainless steel.

According to an embodiment, the carrier plate and the threaded connector are formed as two separate parts that are metallurgically connected, as for example by laser welding.

According to an embodiment, the form of the carrier plate comprises one or more concave and convex sections arranged along the form's outer circumference.

According to an embodiment, the form of the carrier plate comprises one or more round recesses and protrusions along the form's circumference.

The screw head is configured to be driven by a mating tool that engages with the outer shape of the screw head to perform a rotation movement around an axis parallel to the mounting direction.

According to an embodiment, the outer shape of the screw head can have a hexagonal shape. Other shapes that allow the rotational movement driven by an external force or by the engagement of a mating tool are possible as well, as for example a star shape or an octagonal shape.

The screw head is configured to engage with the carrier plate, allowing the transfer of the rotational movement of the screw head to the sensor port.

The screw head may comprise an inner circumference configured to allow an engagement of the screw head with the carrier plate, enabling the transfer of the rotational movement of the screw head to the sensor port, which simplifies the mounting of the sensor arrangement onto a component containing a fluid to be measured.

According to an embodiment, the inner circumference of the screw head may allow a force-fit connection between the screw head and the carrier plate, improving the transfer of the rotational movement of the screw head to the sensor port.

According to an embodiment, the inner circumference the screw head may match the outer circumference of the carrier plate, enabling a form-fit connection between the carrier plate and the screw head. The form-fit connection improves the transfer of the rotational movement of the screw head to the sensor port.

According to an embodiment, an adhesive may be arranged between the carrier plate and the screw head. The adhesive may support the connection between the screw head and the carrier plate by improving the torque transfer from the screw head onto the carrier plate. The adhesive may further provide a fixation of the sensor port in relation to the screw head in a direction parallel to the mounting direction, reducing the risk of the carrier plate slipping out of the screw head. Furthermore, the adhesive may provide a sealing of the inner section of the screw head from the surrounding environment.

For low torque applications a sealing ring can be used instead of an adhesive. The sealing ring may be placed between the screw head and the sensor port to seal the inner section of the screw head from the surrounding environment.

For high torque applications a sealing plate can be used instead of the adhesive or the sealing ring. The sealing plate may be placed in between the screw head and the sensor port in order to seal the inner section of the screw head from the surface environment.

The screw head preferably comprises or consists of a material with a low thermal conductivity. The screw head preferably comprises or consists of a material with a thermal conductivity lower than the thermal conductivity of the sensor port. This results in a low amount of heat transferred from the fluid to be measured or the environment to the sensor control unit, even when using a sensor port comprising a material with a high thermal conductivity, as for example aluminum. The low thermal conductivity of the material of the screw head enhances the thermal decoupling of the sensor control unit from the sensor port and from the environment. This allows the usage of the sensor control unit in an environment with an ambient temperature higher than the maximum operating temperature of the sensor control unit. Furthermore, it allows the sensor control unit to be used in an application in which the fluid temperature is higher than the maximum operating temperature of the sensor control unit.

The screw head preferably comprises or consists of a metal or plastic material. Preferably, a plastic material is used, as for example PPA. Because of its low thermal conductivity, the usage of plastic material enhances the thermal decoupling of the sensor control unit from the aluminum sensor port and the environment, as it equalizes the high thermal conductivity of the aluminum sensor port. The option to use aluminum for the sensor port improves the corrosion resistance of the sensor port.

According to an embodiment, and under certain temperature requirements, the screw head and the sensor port may comprise the same material. The usage of the same material for the sensor port and the screw head either requires a constant control over the temperature of the fluid and the ambient temperature or the usage of the sensor arrangement in a low temperature environment, in order to not destroy the sensor control unit as a consequence of temperatures higher than its maximum operating temperature. The usage of the same material for the screw head and the sensor port enables a reduction of galvanic corrosion compared to a case in which two different metal materials are used for the sensor port and the screw head.

The sensor control unit may be arranged on the screw head.

According to an embodiment, the sensor arrangement may further comprise a plug allowing an open side of the screw head to be closed and allowing the sensor arrangement to be mechanically connected to an external port. The plug may protect the sensor arrangement against dirt, humidity and external forces, for example.

The plug preferably comprises or consists of a plastic material. The plug preferably comprises or consists of the same material as the screw head.

The sensor control unit may be connected to an external port via electrical connectors, allowing for a transmission of the measurement's results to the external port. The electrical connectors may be supported by the plug.

The electrical connectors may be sufficiently robust to allow the sensor control unit to be mechanically connected to the plug via said electrical connectors. This allows the sensor control unit to be spaced apart from the screw head and the carrier plate, improving the thermal decoupling of the sensor control unit from the sensor port.

According to an embodiment, the sensor control unit is spaced apart from the sensor port. This improves the thermal protection of the sensor control unit as the only direct contact of the Sensor control unit to another element of the sensor arrangement is to the electrical connectors connecting the sensor control unit with the sensor element and, depending on the embodiment, to the screw head or to the electrical connectors mechanically connecting the sensor control unit with the plug. The screw head preferably comprises a material with a lower thermal conductivity than the sensor port and the electrical connectors have a contact surface small enough to be neglected concerning a thermal transfer. An improved thermal protection of the sensor control unit enables the usage of the sensor control unit in an environment exceeding the sensor control unit's maximum operating temperature.

The sensor element may be a pressure sensor element or a temperature sensor element, for example.

According to an embodiment, the temperature sensor element can be an NTC thermistor, for example. The NTC thermistor is an abbreviation for a thermally sensitive resistor with a negative temperature coefficient. A change in temperature leads to a change in electrical resistance of the thermistor's material, for example a metal oxide. This change can be measured, and the temperature change can be calculated. Other temperature sensor elements that convert a temperature change into a change of an electrical quantity can be used as well.

According to an embodiment, the pressure sensor element can be a piezoelectric sensor element. The piezoelectric sensor element uses the piezoelectric effect. A change in pressure leads to a change in the applied force on the piezoelectric element. This physical change leads to an electric charge that can be measured and the pressure change can be calculated. Other pressure sensor elements that convert a pressure change into a change of an electrical quantity can be used as well.

According to an embodiment, the sensor arrangement comprises more than one sensor element, allowing for an improved measurement, for example concerning the reliability of the measured data or the amount of different physical quantities that are measured. The several sensor elements may be of a different type, as for example one temperature sensor element and one pressure sensor element, increasing the amount of different physical quantities that can be measured. The several sensor elements may be of the same type, as for example two pressure sensor elements, enabling an improvement of the reliability of the measured data by cross-checking the data obtained from the two sensor elements.

The sensor element may comprise a sensitive surface. The sensitive surface is a surface of the sensor element that may be in contact with the fluid to be measured. It is capable of transforming the properties of the fluid, for example pressure, into a change of the characteristics of the sensor element, leading to a measurable change of the electric quantity that is measured.

According to an embodiment, the threaded connector provides a cavity that enables a direct contact of the fluid to the side of the carrier plate facing in mounting direction. The cavity may further provide a direct contact to the sensor element, if the sensor element is placed on the side of the carrier plate facing in mounting direction.

If the sensor element is placed on the side of the carrier plate facing away from the mounting direction, the carrier plate may provide a channel through the carrier plate, reaching from the side of the carrier plate facing in mounting direction to the sensitive surface of the sensor element placed on the side of the carrier plate facing away from the mounting direction. The channel enables a direct contact of the fluid to the sensitive surface of the sensor element.

According to an embodiment, the sensitive surface of the sensor element, a sealing agent, and a wall of the channel through the carrier plate are configured to seal the end of the channel facing away from the mounting direction, reducing the risk of leakage of the fluid into the sensor arrangement.

The sensor element may comprise or consist of a metal material, preferably stainless steel can be used, for example.

The sensor element may comprise a sensor housing. The sensor housing may comprise a brim that enables an improved connection of the sensor element to the carrier plate, for example by laser welding through the brim. During the laser welding process, a laser beam may be generated by a laser source placed on top of the sensor arrangement. Top is defined as further in a direction facing away from the mounting direction. The laser beam penetrates the brim and melts the carrier plate's surface and the brim, allowing for the two melted materials to fuse. After cooling down, the sensor element and the carrier plate are connected.

The sensor housing may be in the form of a solid housing or in the form of a sleeve surrounding the sensor element. The sensor housing may comprise or consist of a metal material. Preferably, stainless steel can be used, for example.

According to an embodiment, the sensor arrangement is configured to measure physical quantities in high pressure applications of up to 1000 bar.

According to an embodiment, the sensor arrangement is configured to measure physical quantities in high temperature applications of up to 180° C.

### BRIEF DESCRIPTION OF THE DRAWINGS

Further advantageous embodiments may become apparent from the following exemplary embodiments described in connection with the figures. However, the invention is not limited to said exemplary embodiments. Further, said exemplary embodiments are depicted in figures showing schematic drawings. These schematic drawings are not true to scale, and absolute and relative dimensions can be depicted in a distorted manner. Accordingly, no absolute or relative dimensions can be taken from the schematic depictions unless otherwise indicated. Elements that are identical, similar or have the same effect are denoted by the same reference signs in the figures.

FIG. 1 shows a cross-section of a first embodiment of the sensor arrangement. The embodiment comprises a carrier plate, a threaded connector, a screw head, a sensor element, and a sensor control unit.

FIG. 2 shows a cross-section of the first embodiment of the sensor arrangement. The cross-section is derived from the first figure by cutting through the sensor arrangement at the dotted line shown in FIG. 1.

FIG. 3 shows a cross-section of a second embodiment of the sensor arrangement. The embodiment comprises a carrier plate, a threaded connector, a screw head, and two different sensor elements. The embodiment further comprises a sensor control unit, sensor housings and a plug.

### DETAILED DESCRIPTION

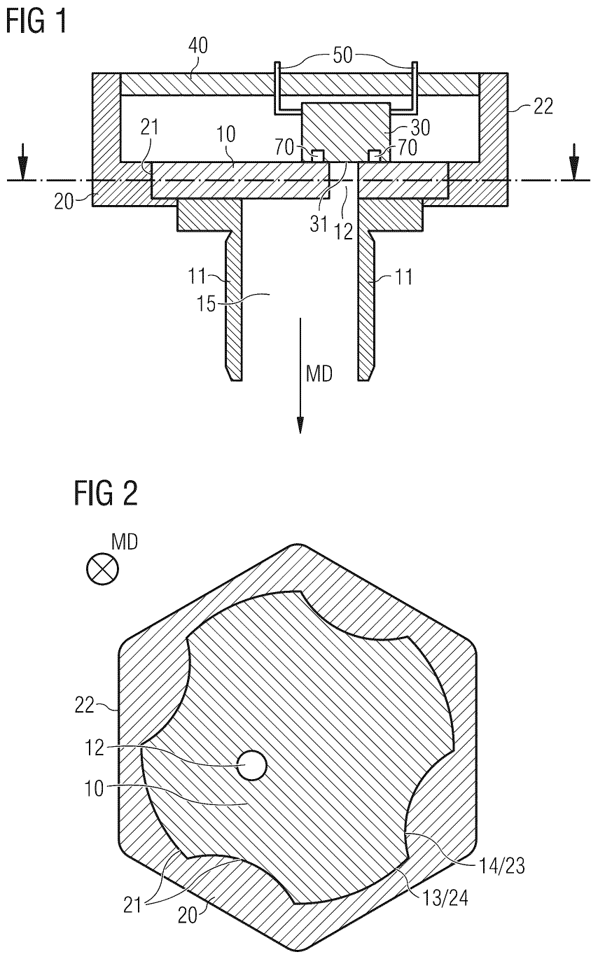

FIG. 1 shows a first embodiment of the sensor arrangement comprising a carrier plate 10, a threaded connector 11, a screw head 20, a sensor element 30, and a sensor control unit 40.

The threaded connector 11 and the carrier plate 10 are formed as two separate parts.

The threaded connector 11 is arranged on the carrier plate 10 on a side of the plate facing in mounting direction MD by a welding connection and extends in the mounting direction MD. The threaded connector 11 enables a simple and fast process of mounting the sensor arrangement by screwing the sensor arrangement into a component containing a fluid to be measured. The threaded connector 11 furthermore allows a simple demounting and replacement of the sensor arrangement in case of a defect component of the sensor arrangement.

The threaded connector 11 is in direct contact with a fluid to be measured. As aluminum is commonly used as material for components containing fluids, the threaded connector 11 consists of aluminum as well, to improve the corrosion resistance.

The carrier plate 10 comprises an overall thickness of 3 mm, enabling the carrier plate 10 to withstand the forces acting on the carrier plate 10, applied by the pressure of the fluid to be measured.

The carrier plate 10 consists of aluminum, to improve the corrosion resistance.

The carrier plate 10 is placed inside the screw head 20, engaging the form-fit connection with screw head 20. The area of engagement 21 of the outer circumference of the carrier plate 10 with the inner circumference of the screw head 20 can be seen at reference sign 21.

The screw head 20 supports the sensor control unit 40, enabling the sensor control unit 40 to be spaced apart from the carrier plate 10. This enables a thermal decoupling of the sensor control unit 40 from the sensor port comprising the carrier plate 10 and the threaded connector 11.

The screw head 20 consists of a plastic material.

The sensor element 30 is a piezoelectric pressure sensor element 30. The sensor element 30 is connected to a side of the carrier plate 10 facing away from a mounting direction MD via a laser welding connection. The sensor element 30 comprises a sensitive surface 31. The sensitive surface 31 transforms a pressure change of the fluid into a change of the electrical characteristics of the sensor element 30. This change can be measured, and the pressure change can be calculated.

The threaded connector 11 provides a cavity 15 that enables a direct contact of the fluid to the side of the carrier plate 10 facing in mounting direction MD. The carrier plate 10 provides a channel 12 that enables a direct contact of the fluid to the sensitive surface 31 of the sensor element 30.

By adding a sealing agent 70 between the sensor element 30 and the carrier plate 10, the walls of the channel 12 of the carrier plate 10, the sealing agent 70, and the sensitive surface 31 of the sensor element 30 seal the end of the channel 12 facing away from the mounting direction MD to reduce the risk of leakage of the fluid.

The sensor element 30 consists of stainless steel.

The sensor element 30 is connected to the sensor control unit 40 via electrical connectors 50, allowing the sensor control unit 40 to measure the changes of an electric quantity of the sensor element 30 to be measured.

FIG. 2 shows a cross-section of FIG. 1. It is obtained by cutting through the sensor arrangement at the dotted line shown in FIG. 1.

FIG. 2 shows the outer shape 22 of the screw head 20, the form of the carrier plate 10, the form of the screw head's 20 inner circumference, and the through hole 12 of the carrier plate 10.

The form of the carrier plate 10 comprises four concave 14 and four convex 13 sections along its circumference that engage with the respective convex 23 or concave 24 sections along the screw head's 20 inner circumference.

The screw head 20 comprises a hexagonal outer shape 22, allowing the engagement of a mating tool initiating a rotational movement of the screw head 20 around an axis parallel to the mounting direction MD.

This rotational movement is transferred onto the carrier plate 10 by the form-fitting connection of the convex 13, 23 and concave 14, 24 sections along the carrier plate's 10 outer circumference and the screw head's 20 inner circumference.

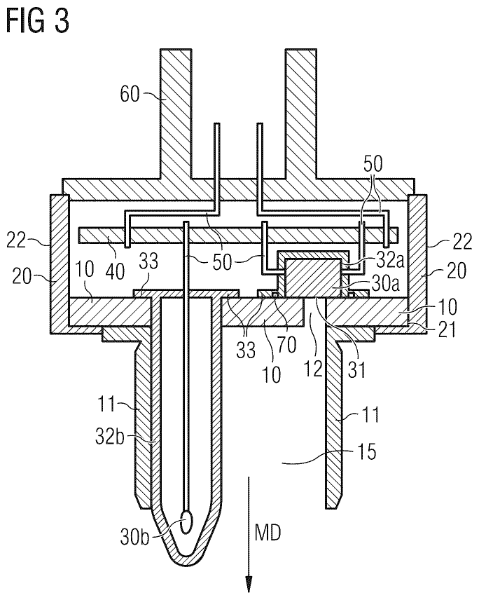

FIG. 3 shows an embodiment of the sensor arrangement comprising a carrier plate 10, a threaded connector 11, a first sensor element 30a and a second sensor element 30b, a screw head 20, a sensor control unit 40, and a plug 60. As the main characteristics of the carrier plate 10, the threaded connector 11, the sensor elements 30a and 30b, the screw head 20 and the sensor control unit 40 are already described in FIG. 1 and FIG. 2, differences of the embodiment shown in FIG. 3 compared to the embodiment shown in FIG. 1 and FIG. 2 will be described in the following.

The threaded connector 11 is arranged on the carrier plate 10 on a side of the carrier plate 10 facing in mounting direction MD, extends in mounting direction MD, and comprises a cavity 15. The threaded connector 11 enables a simple and fast process of mounting and demounting the sensor arrangement by screwing the sensor arrangement into or respectively out of the component containing a fluid to be measured. The threaded connector 11 consists of aluminum, improving the corrosion resistance as already described above.

The carrier plate 10 consists of aluminum and comprises an overall thickness of 3 mm. The thickness allows the carrier plate 10 to withstand the forces applied to the carrier plate 10 by the pressure of the fluid.

The carrier plate 10 is placed inside the screw head 20, the outer circumference of the carrier plate 10 engages a force-fit connection with the inner circumference of the screw head 20. The area of engagement 21 of the two parts can be found at reference sign 21.

The screw head 20 comprises a hexagonal outer shape 22 and consists of a plastic material.

The first sensor element 30a is surrounded by a sensor housing 32a. The first sensor element 30a is a piezoelectric sensor, measuring the pressure of the fluid. The piezoelectric sensor comprises a sensitive surface 31 that is in direct contact with the fluid through a channel 12 of the carrier plate 10 and through the cavity 15 of the threaded connector 11, as already described in FIG. 1. The first sensor element 30a is electrically connected to the sensor control unit 40 by electrical connectors 50.

The second sensor element 30b is surrounded and supported by a sleeve 32b. The second sensor element 30b is an NTC-thermistor, measuring the temperature of the fluid. To improve the measurement's results, the sleeve 32b surrounding the NTC-thermistor is placed inside the fluid, the sleeve 32b reaching further into the fluid than the threaded connector 11 in mounting direction MD. The second sensor element 30b is electrically connected to the sensor control unit 40 by an electrical connector 50.

The sensor housing 32a and the sleeve 32b comprise a brim 33 that enables a laser welding montage of the sensor housing 32a and the sleeve 32b on the carrier plate 10. The brim 33 consists of stainless steel. Both the sensor housing 32a and the sleeve 32b are connected to the carrier plate 10 on a side of the carrier plate 10 facing away from the mounting direction MD by laser welding.

The brims 33 of the sensor housing 32a and the sleeve 32b are laser welded onto the carrier plate 10 on a side of the plate facing away from the mounting direction and consist of stainless steel.

By adding a sealing agent 70 between the brim 33 of the first sensor element's 30a housing 32a and the carrier plate 10, the wall of the channel 12 of the carrier plate 10, the sealing agent 70, and the sensitive surface 31 of the first sensor element 30a seal the end of the channel 12 facing away from the mounting direction MD to reduce the risk of leakage of the fluid into the sensor arrangement.

The sensor arrangement comprises a plug 60 that closes the open side of the screw head 20. The plug 60 also supports the electrical connectors 50 that enable an electrical connection of an external port to the sensor control unit 40, enabling a transmission of the measurement's results to an external port.

The plug 60 consists of the same plastic material as the screw head 20.

The Sensor Control Unit 40 Is Mechanically Connected to the Plug 60 via the electrical connectors 50 connecting the sensor control unit 40 to an external port. This allows the sensor control unit to be spaced apart from the screw head 20, the carrier plate 10 and the threaded connector 11, further enhancing the thermal decoupling of the sensor control unit 40 from the sensor port and the environment.

### LIST OF REFERENCE SIGNS

10 Carrier Plate
11 Threaded Connector
12 Channel Carrier Plate
13 Convex Section Carrier Plate
14 Concave Section Carrier Plate
15 Cavity
20 Screw Head
21 Area of engagement
22 Outer Shape Screw Head
23 Convex Section Screw Head
24 Concave Section Screw Head
30 Sensor Element
30a First Sensor Element
30b Second Sensor Element
31 Sensitive Surface
32a Sensor Housing
32b Sleeve
33 Brim
40 Sensor Control Unit
50 Electrical Connector
60 Plug
70 Sealing Agent
MD Mounting Direction

1-22. (canceled)

23. A sensor arrangement, comprising
at least one sensor element for transforming a physical quantity into a measurable electrical quantity;
a sensor port comprising a carrier plate and a threaded connector connected to the carrier plate, the at least one sensor element is arranged directly on the sensor port;
a screw head configured to be driven by a mating tool to perform a rotation movement around an axis parallel to the mounting direction, the screw head is configured to engage with the carrier plate in a way as to allow the transfer of the rotation movement of the screw head to the sensor port; and
a sensor control unit electrically controlling the operation of the sensor element, wherein the sensor control unit is arranged in a way that the sensor control unit is thermally decoupled from the sensor port.

24. The sensor arrangement according to claim 23, wherein the sensor control unit is spaced apart from the sensor port.

25. The sensor arrangement according to claim 23, wherein the threaded connector is arranged on a side of the carrier plate facing in a mounting direction and wherein the sensor element is arranged on the carrier plate on a side of the carrier plate facing away from the mounting direction.

26. The sensor arrangement according to claim 23, wherein the carrier plate and the threaded connector are formed as one single element.

27. The sensor arrangement according to claim 23, wherein the screw head comprises an inner circumference that is configured to enable the engagement of the screw head with the carrier plate.

28. The sensor arrangement according to claim 27, wherein the inner circumference of the screw head engages an outer circumference of the carrier plate in a force-fit connection.

29. The sensor arrangement according to claim 28, wherein the inner circumference of the screw head matches the outer circumference of the carrier plate to enable the form-fit connection.

30. The sensor arrangement according to claim 27, wherein an outer circumference of the carrier plate and the inner circumference of the screw head comprise concave and convex sections.

31. The sensor arrangement according to claim 27, wherein an outer circumference of the carrier plate and the inner circumference of the screw head comprise round-shaped recesses and protrusions.

32. The sensor arrangement according to claim 23, wherein the screw head comprises a material with a lower thermal conductivity than the material of the sensor port.

33. The sensor arrangement according to claim 23, wherein the sensor port comprises a metal.

34. The sensor arrangement according to claim 33, wherein the sensor port comprises aluminum.

35. The sensor arrangement according to claim 33, wherein the screw head comprises a metal.

36. The sensor arrangement according to claim 33, wherein the screw head comprises a plastic material.

37. The sensor arrangement according to claim 23, wherein an adhesive is arranged between the screw head and the sensor port, wherein the adhesive supports the engagement between screw head and the carrier plate by providing a fixation of the carrier plate in relation to the screw head in an axial direction and a sealing of an inner section of the screw head from the surrounding environment.

38. The sensor arrangement according to claim 23, further including a sealing ring or a sealing plate for sealing an inner section of the screw head from the surrounding environment.

39. The sensor arrangement according to claim 23, wherein the sensor element is a pressure sensor element or a temperature sensor element.

40. The sensor arrangement according to claim 23, wherein the at least one sensor element comprises a plurality of sensor elements.

41. The sensor arrangement according to claim 23, wherein the sensor arrangement is configured to measure physical quantities in high pressure applications of up to 1000 bar.

42. The sensor arrangement according to claim 23, wherein the sensor arrangement is configured to measure physical quantities in high temperature applications of up to 180° C.

43. The sensor arrangement according to claim 23, wherein the sensor control unit is arranged on the screw head.

44. The sensor arrangement according to claim 23, further comprising a plug for closing an open side of the screw head, wherein the sensor control unit is mechanically connected to the plug by electrical connectors.
